(19) United States
(12) Patent Application Publication
(10) Pub. No.: US 2024/0153249 A1
(43) Pub. Date: May 9, 2024

(54) INTERMODAL SENSOR TRAINING

(71) Applicant: QUALCOMM Incorporated, San Diego, CA (US)

(72) Inventors: Shubhankar Mangesh Borse, San Diego, CA (US); Marvin Richard Klingner, Braunschweig (DE); Varun Ravi Kumar, San Diego, CA (US); Senthil Kumar Yogamani, Headford (IE); Fatih Murat Porikli, San Diego, CA (US)

(21) Appl. No.: 18/467,455

(22) Filed: Sep. 14, 2023

Related U.S. Application Data
(60) Provisional application No. 63/383,024, filed on Nov. 9, 2022.

(51) Int. Cl. G06V 10/774; G06V 10/26; G06V 10/40; G06V 10/80; G06V 20/56

(52) U.S. Cl. CPC G06V 10/774; G06V 10/26; G06V 10/40; G06V 10/803; G06V 20/56

(57) ABSTRACT

This disclosure provides systems, methods, and devices for image signal processing that support training object recognition models. In a first aspect, a method of image processing includes training a first modality imaging system; receiving time-synchronized first input data samples and second input data samples from the first modality imaging system and a second modality imaging system, respectively; processing the first input data samples in the first modality imaging system to generate first output; processing the second input data samples in the second modality imaging system to generate second output; and training the second modality imaging system based on the first output and the second output. Other aspects and features are also claimed and described.

### CROSS-REFERENCE TO RELATED APPLICATIONS

This application claims the benefit of U.S. Provisional Patent Application No. 63/383,024, entitled, “INTERMODAL SENSOR TRAINING,” filed on Nov. 9, 2022, which is expressly incorporated by reference herein in its entirety.

### TECHNICAL FIELD

Aspects of the present disclosure relate generally to image processing, and more particularly, to object detection. Some features may enable and provide improved image processing, including training models for performing object detection.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The amount of image data captured by an image sensor has increased through subsequent generations of image capture devices. The amount of information captured by an image sensor is related to a number of pixels in an image sensor of the image capture device, which may be measured as a number of megapixels indicating the number of millions of sensors in the image sensor. For example, a 12-megapixel image sensor has 12 million pixels. Higher megapixel values generally represent higher resolution images that are more desirable for viewing by the user.

The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

In some aspects, different modes of sensor systems may be used to improve the training of a model for object detection in an image processing system. For example, in some systems a LIDAR system, which has the capability of sensing position and perception of a scene, may be used to improve training for understanding input image data from a camera-based 3D object detection system. The camera-based system may have difficulty precisely locating objects in 3D space because the camera-based processing involves a projection from a perspective view (PV) to a birds-eye view (BEV) that is difficult to train for the camera-based system based on missing explicit guidance. The LIDAR system provides better 3D object detection models because the LIDAR system provides more precise geometry information from a processed LIDAR point cloud.

In one example of intermodal training of a camera-based system with input data from a LIDAR system, a method may include training a LIDAR-based model; receiving time-synchronized first and second input data samples from the LIDAR system and the camera system, respectively; processing the first input data samples through the LIDAR-based model to obtain a first output; processing the second input data samples through the camera-based model to obtain a second output; and training the camera-based model during processing of the second input data samples using the first output of the LIDAR-based model and/or intermediate features of the LIDAR-based model. With the camera-based model trained, the LIDAR system may be deactivated for power savings and/or removed for cost savings. Then, the method may include receiving third input data samples from the camera system, and processing the third input data samples with the camera-based model based on training from the LIDAR-based model.

In some embodiments, a first approach for the image processing system learns an extra set of features compared to the camera-only model, which are divergent from the camera as they are highly sparse when visualized. In some embodiments, a second approach for the image processing system the lifting operation from camera to BEV contains more accurate predictions on small and faraway objects.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1A is a perspective view of a motor vehicle with a driver monitoring system according to embodiments of this disclosure.

FIG. 1B shows a block diagram of an example device for performing image capture from one or more image sensors.

FIG. 2 is a block diagram illustrating an example data flow path for image data processing in an image capture device according to one or more embodiments of the disclosure.

FIG. 3 is a block diagram illustrating details of an example wireless communication system according to one or more aspects.

FIG. 4A shows a block diagram illustrating processing of image data in a LIDAR-based system according to some embodiments of the disclosure.

FIG. 4B shows a block diagram illustrating processing of image data in a camera-based system according to some embodiments of the disclosure.

FIG. 5 shows a block diagram illustrating weakly-supervised learning in the camera-based system from the LIDAR-based system according to some embodiments of the disclosure.

FIG. 6 shows a block diagram illustrating ground-truth enhanced learning in the camera-based system from the LIDAR-based system according to some embodiments of the disclosure.

FIG. 7A shows a block diagram illustrating intermediate camera features from the LIDAR-based system according to some embodiments of the disclosure.

FIG. 7B shows a block diagram illustrating correlating a portion of intermediate camera features from the LIDAR-based system according to some embodiments of the disclosure.

FIG. 8A shows a flow chart of an example method for processing image data to train a second modality image system with first modality image system data according to some embodiments of the disclosure.

FIG. 8B shows a flow chart of an example method for processing image data in a second modality image system trained with first modality image system data according to some embodiments of the disclosure.

FIG. 9 is a block diagram illustrating an example processor configuration for image data processing in an image capture device according to one or more embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for object detection, and may be particularly beneficial in smart vehicle applications. The provided techniques involve training an image processing system of a first modality (e.g., a camera-based image processing system) based on a first output of the first modality's image processing system and on a second output of an image processing system of a second modality (e.g., a LiDAR-based image processing system). Specifically, a model associated with the first modality's image processing system is trained based on the first and second outputs.

Particular implementations of the subject matter described in this disclosure may be implemented to realize one or more of the following potential advantages or benefits. In some aspects, the present disclosure provides techniques for improved object detection in camera-based system by using training information from a different modality of sensing system. The improved object detection improves the accuracy of downstream perception tasks that utilize these features to provide vehicle assistance services. In particular, these techniques may enable more accurate tracking of vehicles, pedestrians, obstacles, road signage, road markings, and the like.

One benefit of improved tracking is that it allows vehicle control systems to more accurately navigate vehicles around obstacles. This can be particularly useful in situations where there may be unexpected obstructions or road conditions that could pose a hazard to drivers. Additionally, improved tracking can help to improve overall safety on the roads by reducing vehicle collisions. With better tracking capabilities, vehicles can be made more responsive to nearby obstacles and can be routed around detected obstacles more efficiently. These improvements can also extend to driver assistance systems, which can benefit from increased monitoring capabilities. By expanding the number, type, and variety of surrounding objects that can be detected, these systems can offer more accurate alerts and assistance to drivers when necessary, without generating unnecessary notifications or distractions.

An example device for capturing image frames using one or more image sensors, such as a smartphone, may include a configuration of one, two, three, four, or more cameras on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames in a memory and/or otherwise provide the output image frames to processing circuitry (such as through a bus). The processing circuitry may perform further processing, such as for encoding, storage, transmission, or other manipulation of the output image frames.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

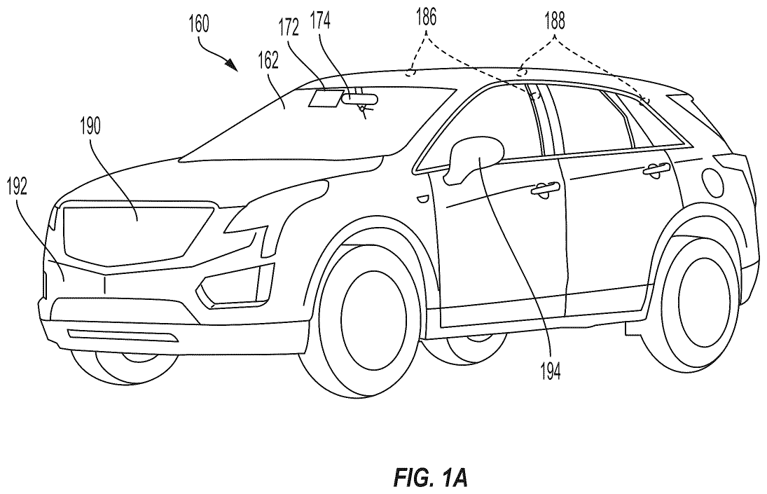

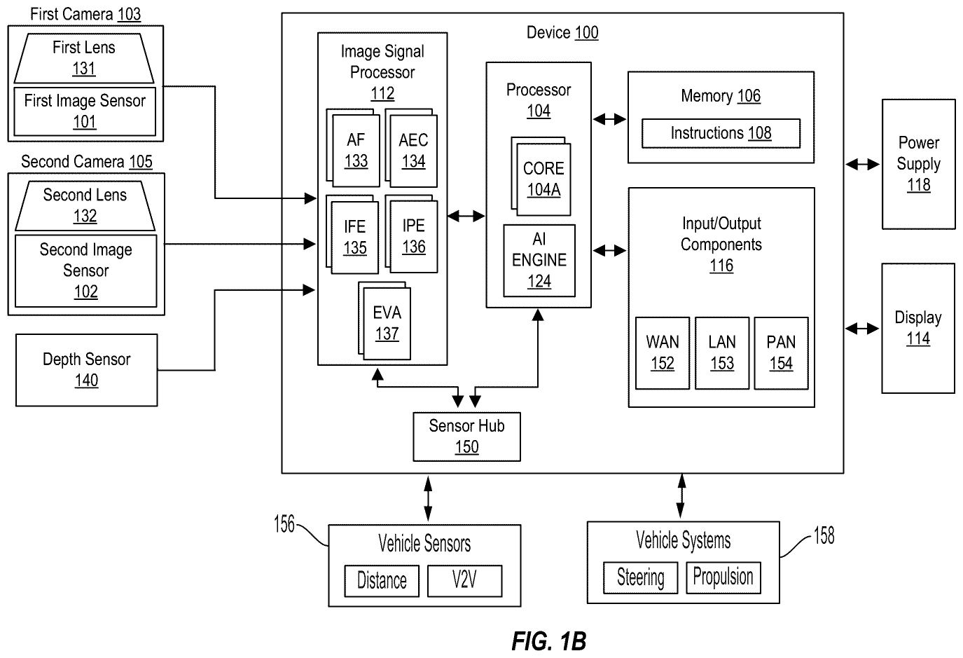

FIG. 1A is a perspective view of a motor vehicle with a driver monitoring system according to embodiments of this disclosure. A vehicle 160 may include a front-facing camera 172 mounted inside the cabin looking through the windshield 162. The vehicle may also include a cabin-facing camera 174 mounted inside the cabin looking towards occupants of the vehicle 160, and in particular the driver of the vehicle 160. Although one set of mounting positions for cameras 172 and 174 are shown for vehicle 160, other mounting locations may be used for the cameras 172 and 174. For example, one or more cameras may be mounted on one of the driver or passenger B pillars 186 or one of the driver or passenger C pillars 188, such as near the top of the pillars 186 or 188. As another example, one or more cameras may be mounted at the front of vehicle 160, such as behind the radiator grill 190 or integrated with bumper 192. As a further example, one or more cameras may be mounted as part of a driver or passenger side mirror assembly 194.

The camera 172 may be oriented such that the field of view of camera 172 captures a scene in front of the vehicle 160 in the direction that the vehicle 160 is moving when in drive mode or forward direction. In some embodiments, an additional camera may be located at the rear of the vehicle 160 and oriented such that the field of view of the additional camera captures a scene behind the vehicle 160 in the direction that the vehicle 160 is moving when in reverse direction. Although embodiments of the disclosure may be described with reference to a “front-facing” camera, referring to camera 172, aspects of the disclosure may be applied similarly to a “rear-facing” camera facing in the reverse direction of the vehicle 160. Thus, the benefits obtained while the operator is driving the vehicle 160 in a forward direction may likewise be obtained while the operator is driving the vehicle 160 in a reverse direction.

Further, although embodiments of the disclosure may be described with reference a “front-facing” camera, referring to camera 172, aspects of the disclosure may be applied similarly to an input received from an array of cameras mounted around the vehicle 160 to provide a larger field of view, which may be as large as 360 degrees around parallel to the ground and/or as large as 360 degrees around a vertical direction perpendicular to the ground. For example, additional cameras may be mounted around the outside of vehicle 160, such as on or integrated in the doors, on or integrated in the wheels, on or integrated in the bumpers, on or integrated in the hood, and/or on or integrated in the roof.

The camera 174 may be oriented such that the field of view of camera 174 captures a scene in the cabin of the vehicle and includes the user operator of the vehicle, and in particular the face of the user operator of the vehicle with sufficient detail to discern a gaze direction of the user operator.

Each of the cameras 172 and 174 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

FIG. 1B shows a block diagram of an example device 100 (e.g., vehicle 160) for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons.

I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands.

The device 100 may further include or be coupled to a power supply 118 for the device 100, such as a battery or a component to couple the device 100 to an energy source. The device 100 may also include or be coupled to additional features or components that are not shown in FIG. 1B. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In some aspects, a gyroscope in an electronic image stabilization system (EIS) may be coupled to the sensor hub or coupled directly to the image signal processor 112. In further examples, a non-camera sensor may be a global positioning system (GPS) receiver, a light detection and ranging (LiDAR) system, a radio detection and ranging (RADAR) system, or other ranging systems. For example, the sensor hub 150 may interface to a vehicle bus for sending configuration commands and/or receiving information from vehicle sensors 156, such as distance (e.g., ranging) sensors or vehicle-to-vehicle (V2V) sensors (e.g., sensors for receiving information from nearby vehicles).

The image signal processor 112 may receive image data, such as used to form image frames. In one embodiment, a local bus connection couples the image signal processor 112 to image sensors 101 and 102 of a first camera 103 and second camera 105, respectively. In another embodiment, a wire interface couples the image signal processor 112 to an external image sensor. In a further embodiment, a wireless interface couples the image signal processor 112 to the image sensor 101, 102.

The first camera 103 may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The camera 103 may be a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. The camera 103 may have different characteristics based on the current aperture size, such as a different depth of focus (DOF) at different aperture sizes.

The image signal processor 112 processes image frames captured by the image sensors 101 and 102. While FIG. 1B illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112, and output from the depth sensors are processed in a similar manner to that of image sensors 101 and 102. Example depth sensors include active sensors, including one or more of indirect Time of Flight (iToF), direct Time of Flight (dToF), light detection and ranging (Lidar), mmWave, radio detection and ranging (Radar), and/or hybrid depth sensors, such as structured light. In embodiments without a depth sensor 140, similar information regarding depth of objects or a depth map may be generated in a passive manner from the disparity between two image sensors (e.g., using depth-from-disparity or depth-from-stereo), phase detection auto-focus (PDAF) sensors, or the like. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), one or more auto exposure compensation (AEC) 134 engines, and/or one or more engines for video analytics (EVAs). The AF 133, AEC 134, IFE 135, IPE 136, and EVA 137 may each include application-specific circuitry, be embodied as software code executed by the ISP 112, and/or a combination of hardware and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system-on-chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including object detection and model training operations. For example, execution of the instructions can instruct the image signal processor 112 to begin or end capturing an image frame or a sequence of image frames, in which the capture includes a scene with objects as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, a camera application executing on processor 104 may receive a user command to begin a video preview display upon which a video comprising a sequence of image frames is captured and processed from one or more image sensors 101 or 102 through the image signal processor 112. Image processing to generate “output” or “corrected” image frames, such as according to techniques described herein, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 or other co-processor) to offload certain tasks from the cores 104A. The AI engine 124 may be used to offload tasks related to, for example, face detection and/or object recognition. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 158 including propulsion (e.g., commands to increase or decrease speed or apply brakes) and steering systems (e.g., commands to turn wheels, change a route, or change a final destination). The accuracy of the output of commands to the vehicle systems 158 may be improved according to embodiments of this disclosure by training a camera-based system with input data from a LIDAR system to improve object detection that can affect the commands sent to the vehicle systems 158.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1B to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

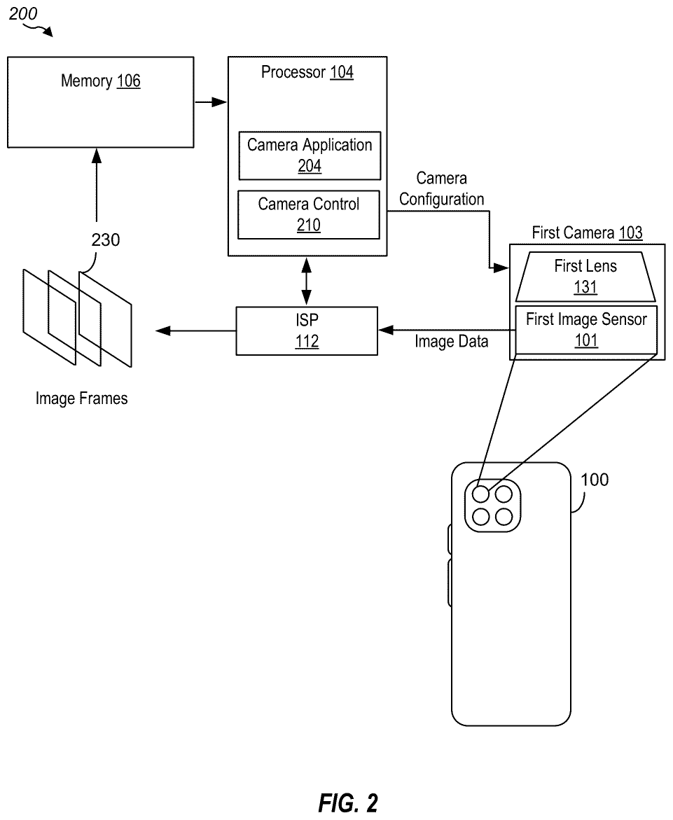

The exemplary image capture device of FIG. 1B may be operated to obtain improved images by better detecting objects in the scene of the image. One example method of operating one or more cameras, such as camera 103, is shown in FIG. 2 and described below.

FIG. 2 is a block diagram illustrating an example data flow path for image data processing in an image capture device according to one or more embodiments of the disclosure. A processor 104 of system 200 may communicate with image signal processor (ISP) 112 through a bi-directional bus and/or separate control and data lines. The processor 104 may control camera 103 through camera control 210, such as for configuring the camera 103 through a driver executing on the processor 104. The camera control 210 may be managed by a camera application 204 executing on the processor 104, which provides settings accessible to a user such that a user can specify individual camera settings or select a profile with corresponding camera settings. The camera control 210 communicates with the camera 103 to configure the camera 103 in accordance with commands received from the camera application 204. The camera application 204 may be, for example, a photography application, a document scanning application, a messaging application, or other application that processes image data acquired from camera 103.

The camera configuration may parameters that specify, for example, a frame rate, an image resolution, a readout duration, an exposure level, an aspect ratio, an aperture size, etc. The camera 103 may obtain image data based on the camera configuration. For example, the processor 104 may execute a camera application 204 to instruct camera 103, through camera control 210, to set a first camera configuration for the camera 103, to obtain first image data from the camera 103 operating in the first camera configuration, to instruct camera 103 to set a second camera configuration for the camera 103, and to obtain second image data from the camera 103 operating in the second camera configuration.

In some embodiments in which camera 103 is a variable aperture (VA) camera system, the processor 104 may execute a camera application 204 to instruct camera 103 to configure to a first aperture size, obtain first image data from the camera 103, instruct camera 103 to configure to a second aperture size, and obtain second image data from the camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 is a larger aperture size than f/8.0.

The image data received from camera 103 may be processed in one or more blocks of the ISP 112 to form image frames 230 that are stored in memory 106 and/or provided to the processor 104. The processor 104 may further process the image data to apply effects to the image frames 230. Effects may include Bokeh, lighting, color casting, and/or high dynamic range (HDR) merging. In some embodiments, functionality may be embedded in a different component, such as the ISP 112, a DSP, an ASIC, or other custom logic circuit for performing the additional image processing.

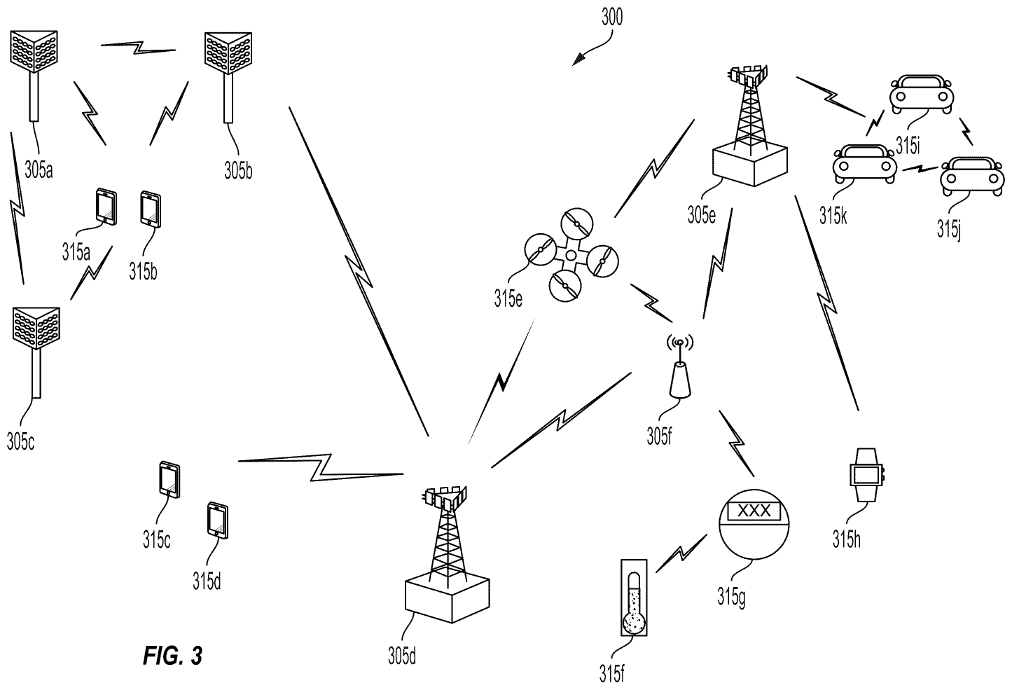

The device 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports communications with ultra-reliable and redundant links for certain devices. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

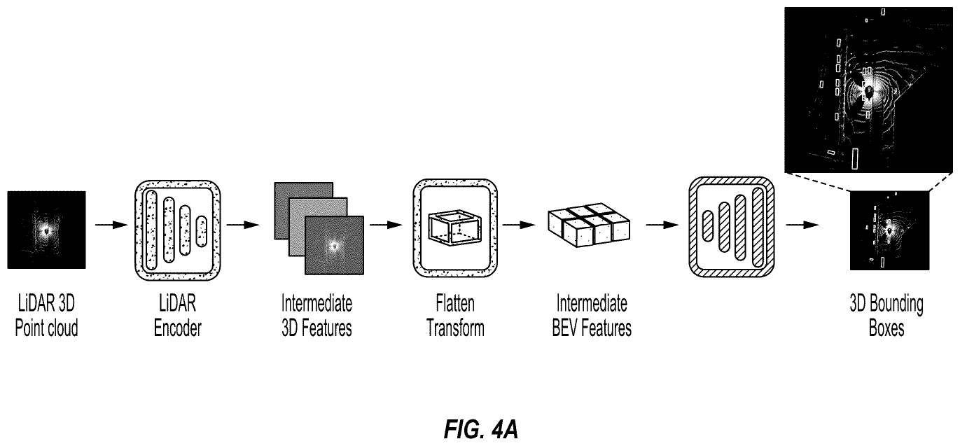

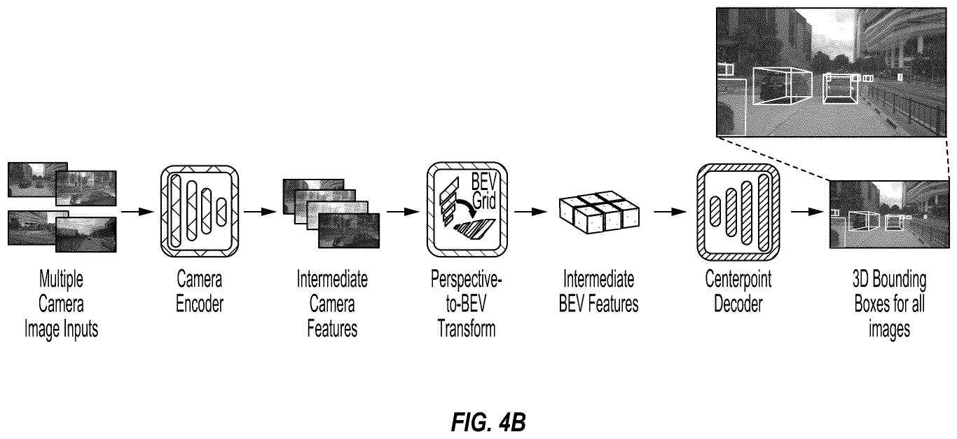

FIG. 4A shows a block diagram illustrating processing of image data in a LiDAR-based system according to some embodiments of the disclosure. The data flow of FIG. 4A illustrates one example of a LiDAR image processing system. Upon receiving point cloud data as input (e.g., from depth sensor 140), the LiDAR-based system includes an encoder that extracts intermediate 3D features from the point cloud data. The LiDAR-based system thereafter flattens the intermediate 3D features in two dimensions to determine intermediate BEV features. A decoder of the LiDAR-based system predicts 3D bounding boxes from the intermediate BEV features. In various aspects, the LiDAR-based system includes a model for executing the above actions of the LiDAR-based system. For example, the model of the LiDAR-based system may be implemented as one or more machine learning models, including supervised learning models, unsupervised learning models, other types of machine learning models, and/or other types of predictive models. For example, the model may be implemented as one or more of a neural network, a transformer model, a decision tree model, a support vector machine, a Bayesian network, a classifier model, a regression model, and the like. In at least some aspects, the model of the LIDAR-based system are trained using ground truth annotations and are fixed afterwards for the knowledge transfer to the camera model.

FIG. 4B shows a block diagram illustrating processing of image data in a camera-based system according to some embodiments of the disclosure. The data flow of FIG. 4B illustrates one example of a camera image processing system. Upon receiving camera image data as input (e.g., from first image sensor 101 and second image sensor 102), the camera-based system includes an encoder that extracts intermediate perspective view camera image features from the camera image data. The camera-based system thereafter transforms the intermediate perspective view camera image features into the BEV plane to determine intermediate BEV features. A decoder of the camera-based system predicts 3D bounding boxes from the intermediate BEV features. In various aspects, the camera-based system includes a model for executing the above actions of the camera-based system. For example, the model of the camera-based system may be implemented as one or more machine learning models, including supervised learning models, unsupervised learning models, other types of machine learning models, and/or other types of predictive models. For example, the model may be implemented as one or more of a neural network, a transformer model, a decision tree model, a support vector machine, a Bayesian network, a classifier model, a regression model, and the like.

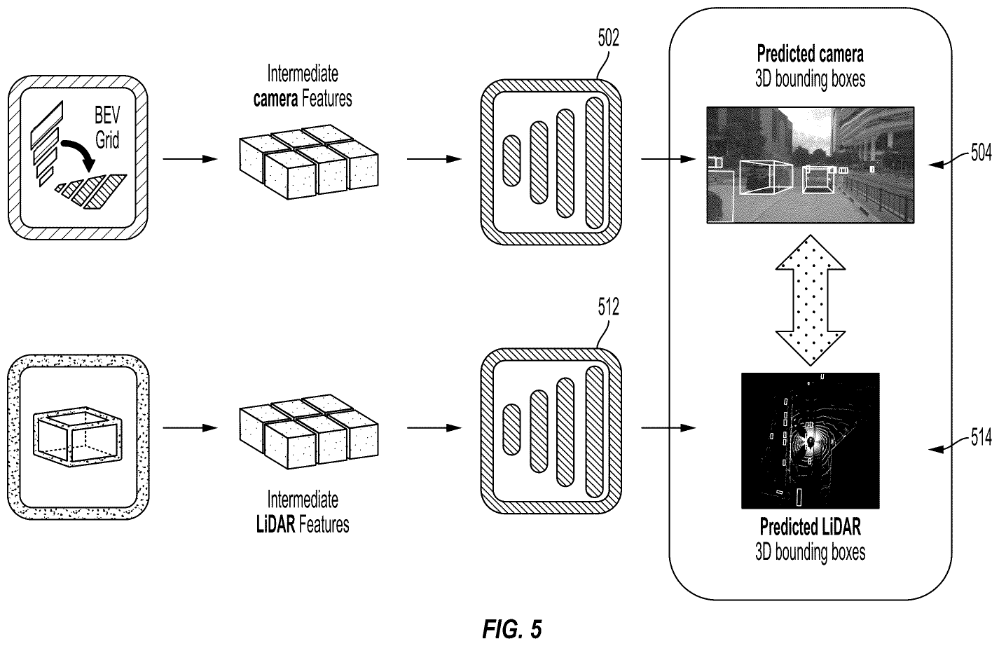

FIG. 5 shows a block diagram illustrating weakly-supervised learning in the camera-based system from the LIDAR-based system according to some embodiments of the disclosure. Output 504 of the camera-based decoder 502 includes a set of 3D bounding boxes within a scene. Output 514 of the LiDAR-based decoder 512 includes a set of 3D bounding boxes within the scene. The outputs 504 and 514 may be compared in a weakly-supervised learning process in which the output 504 may be improved based on the output 514. The camera-based system is thereby improved based on the output 514 to improve the detection of objects in the scene.

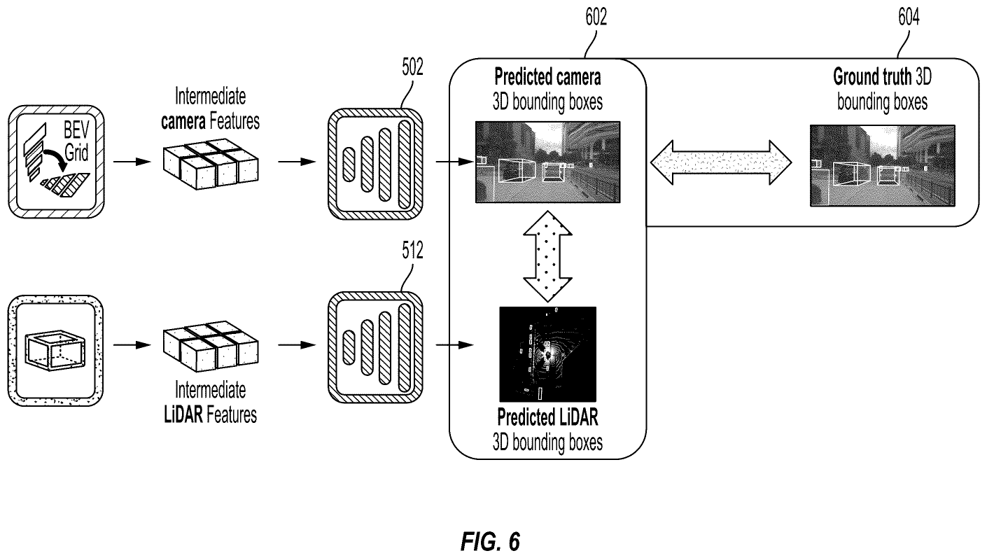

FIG. 6 shows a block diagram illustrating ground-truth enhanced learning in the camera-based system from the LIDAR-based system according to some embodiments of the disclosure. The data processing in FIG. 6 is similar to that in FIG. 5. A comparison process 602 may compare the output 514 of the LIDAR-based system with the output 504 of the camera-based system. Ground truth bounding boxes 604, which may indicate known and/or confirmed objects, such as selected by a human, may be used to improve the camera-based model in addition to the output 514.

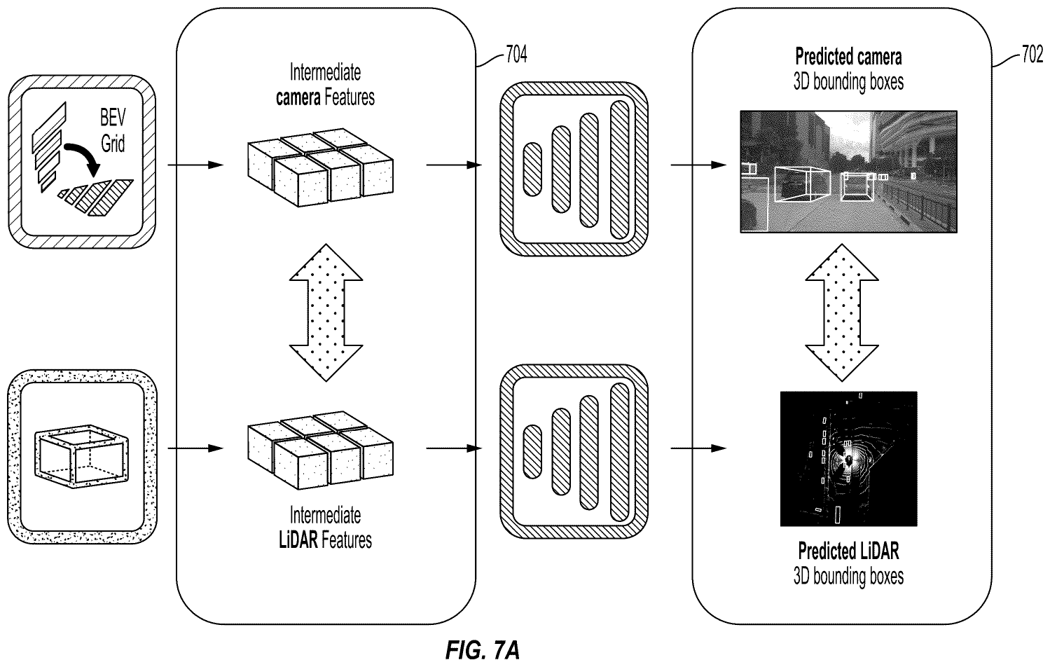

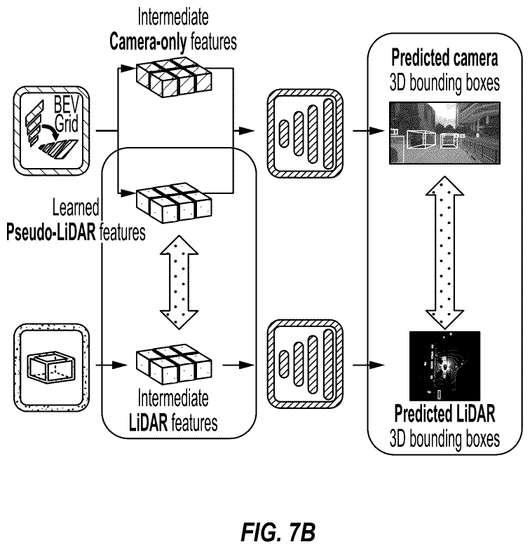

FIG. 7A shows a block diagram illustrating comparison of camera features and LIDAR features according to some embodiments of the disclosure. A comparison process 702 may compare the output 514 of the LIDAR-based system with the output 504 of the camera-based system, which may be used to update an object recognition model of the camera-based system. In addition, LiDAR feature maps can be directly learnt in the camera-based system after equalization. For example, intermediate features of the camera-based model may be compared as part of a process 704 with intermediate features of the LiDAR-based model, and the comparison may be used to update the camera-based model.

FIG. 7B shows a block diagram illustrating pseudo-LiDAR camera features that are learned from the LIDAR-based system according to some embodiments of the disclosure. The data flow of FIG. 7B illustrates generative feature distillation. In the processing of FIG. 7B, ‘Pseudo-Lidar’ feature maps can be directly learnt in the camera-based system after equalization, which are different from the camera-only features. That is, in at least some aspects, only matched intermediate features between the intermediate LiDAR features and the intermediate camera features are used for training the camera-based system. Based on this training of the camera-based system, in various aspects, the LiDAR-based system is not utilized during the inference stage. Stated differently, in these aspects, the processing performed by the camera-based system remains the same as that shown in FIG. 4B at the inference stage, though the outputs 504 generated by the camera-based system are improved based on using the LiDAR-based system to train the camera-based system.

In some embodiments, the methods herein may include training an extra adversarial network on top of the 3D prediction, to predict if the learned outputs are from “Annotated GT” or “Pseudo-GT.”

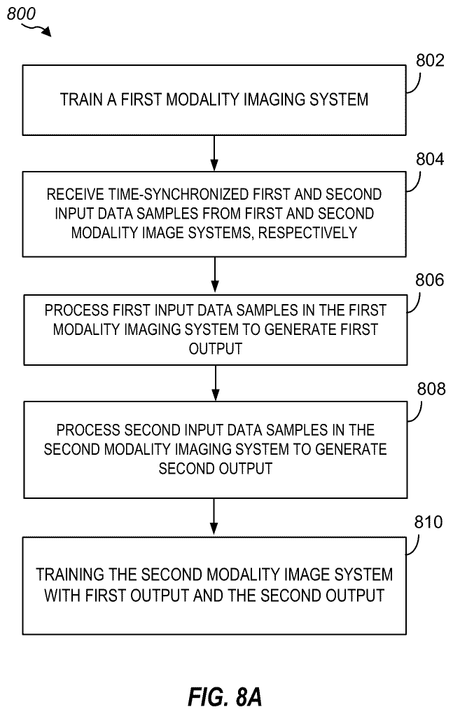

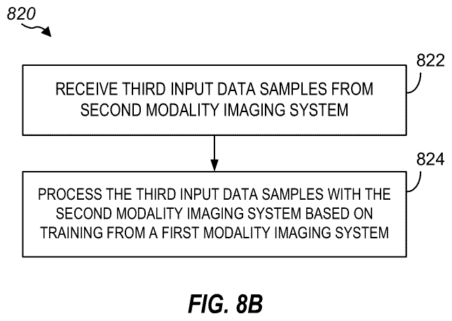

The system 200 of FIG. 2 may be configured to perform the operations described with reference to the data flow charts of FIGS. 3, 4, 5, 6, 7A, and 7B or the method flow charts of FIG. 8A, 8B, or 9. The processing may be performed based on received image data. First image data is received from the image sensor, such as while the image sensor is configured with the camera configuration. For example, the first image data may be received at ISP 112, processed through an image front end (IFE) and/or an image post-processing engine (IPE) of the ISP 112, and stored in memory, such as memory 106. In some embodiments, the capture of image data may be initiated by a camera application executing on the processor 104, which causes camera control 210 to activate capture of image data by the camera 103, and cause the image data to be supplied to a processor, such as processor 104 or ISP 112.

One method of performing image processing according to embodiments described above is shown in FIG. 8A. FIG. 8A is a flow chart illustrating an example method 800 for processing image data to train a second modality image system with first modality image system data. Method 800 includes, at block 802, training a first modality imaging system (e.g., a LiDAR-based system).

At block 804, time-synchronized first and second input data samples are received from the first modality image system and a second modality image system (e.g., a camera-based system), respectively. Stated differently, the first input data samples (e.g., first point cloud data) are received from the LiDAR-based system and the second input data samples (e.g., first image data) are received from the camera-based system, and the first point cloud data is time-synchronized with the first image data. In various aspects, training the LiDAR-based system includes receiving third input data samples (e.g., second point cloud data) from the LiDAR-based system, and determining a model for the LiDAR-based system based on the first point cloud data and a first ground truth corresponding to the first point cloud data.

At block 806, the first point cloud data is processed in the LiDAR-based system to generate a first output (e.g., output 514). In various aspects, processing the point cloud data in the LiDAR-based system includes determining intermediate 3D point cloud features based on the first point cloud data, and processing the first image data in the camera-based system includes determining intermediate camera features based on the first image data. In such aspects, method 800 may further include training the camera-based system based on the intermediate 3D point cloud features. The intermediate 3D point cloud features may be extracted from the first point cloud data by a first encoder (e.g., see FIG. 4A). The intermediate camera features may be extracted from the first image data by a second encoder (e.g., see FIG. 4B).

At block 808, the image data is processed in the camera-based system to generate a second output (e.g., output 504). In various aspects, the output 514 includes a first plurality of bounding boxes corresponding to objects in a scene, and the output 504 includes a second plurality of bounding boxes corresponding to objects in a scene. In such aspects, training the camera-based system includes training the camera-based system with a subset of the objects in the scene that are in both the first plurality of bounding boxes and the second plurality of bounding boxes.

At block 810, the camera-based system is trained with both output 504 and output 514. Stated differently, the camera-based system is trained based on output from the camera-based system and on output from the LiDAR-based system.

One method of performing image processing using the trained camera-based system according to embodiments described above is shown in FIG. 8B. FIG. 8B is a flow chart of an example method 820 for processing image data in a second modality image system (e.g., a camera-based system) trained with data output by a first modality image system (e.g., a LiDAR-based system). It will be appreciated that one or more blocks of method 800 may be combined with one or more blocks of method 820. Method 820 includes, at block 822, receiving third input data samples (e.g., second image data) from the camera-based system.

At block 824, the second image data is processed in the camera-based system to generate a third output based on a model for the camera-based system that is trained based on output (e.g., output 504) of a first modality imaging system (e.g., a LiDAR-based system). Based on the training from the LiDAR-based system, the third output may be more accurate than an output (e.g., output 504) generated by the camera-based system prior to the training from the LiDAR-based system. In various aspects, the third output includes at least one bounding box corresponding to objects detected in the second image data. In some aspects, method 820 may include operating a vehicle based on the at least one bounding box.

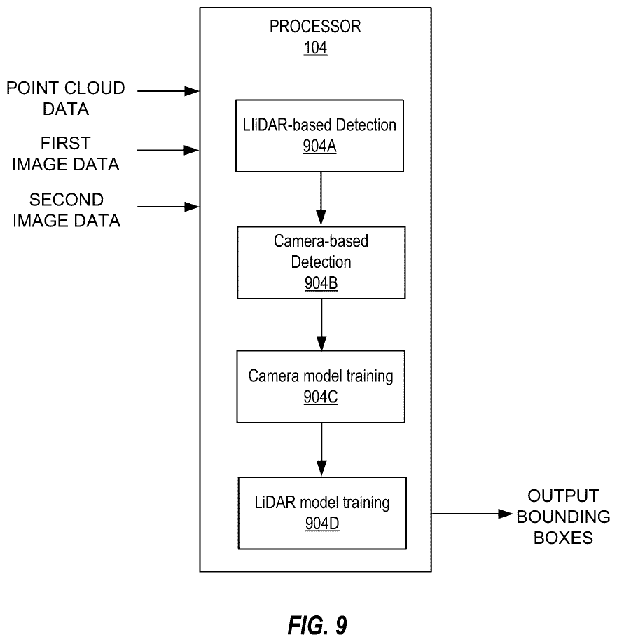

FIG. 9 is a block diagram illustrating an example configuration of processor 104 for image data processing in an image capture device according to one or more embodiments of the disclosure. In this example, point cloud data and first image data are received at processor 104 as inputs. Processor 104 performs LiDAR-based detection 904A on the input point cloud data to extract intermediate features of the input point cloud data, determine 3D bounding boxes based on the input point cloud data, or both. Processor 104 also performs camera-based detection 904B on the input first image data to extract intermediate features of the input first image data, determine 3D bounding boxes based on the input first image data, or both. Processor 104 further performs camera model training 904C to train a model associated with the camera based on the LiDAR intermediate features and the camera intermediate features, the LiDAR 3D bounding boxes and the camera 3D bounding boxes, or both. Processor 104 can additionally perform LiDAR model training 904D to train a model associated with the LiDAR sensor based on the LiDAR 3D bounding boxes and a ground truth set of 3D bounding boxes. With the camera model trained, processor 104 may receive second image data as input and output 3D bounding boxes based on the trained camera model and the second image data.

In one or more aspects, techniques for supporting image processing, which may support vehicular operations, may include additional aspects, such as any single aspect or any combination of aspects described below or in connection with one or more other processes or devices described elsewhere herein. In a first aspect, an apparatus is configured to perform operations including training a first modality imaging system; receiving time-synchronized first input data samples and second input data samples from the first modality imaging system and a second modality imaging system, respectively; processing the first input data samples in the first modality imaging system to generate first output; processing the second input data samples in the second modality imaging system to generate second output; and training the second modality imaging system based on the first output and the second output. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, training the first modality imaging system includes: receiving third input data samples from the first modality imaging system; and determining a model for the first modality imaging system based on the first input data samples and a first ground truth corresponding to the first input data sample.

In a third aspect, in combination with one or more of the first aspect or the second aspect, the operations further include receiving third input data samples from the second modality imaging system; and processing the third input data samples in the second modality imaging system to generate third output based on a model for the second modality imaging system that is trained based on the first output of the first modality imaging system.

In a fourth aspect, in combination with the third aspect, the third output comprises at least one bounding box corresponding to objects detected in the third input data samples.

In a fifth aspect, in combination with the fourth aspect, the operations further include operating a vehicle based on the at least one bounding box.

In a sixth aspect, in combination with one or more of the first aspect through the fifth aspect, the first modality imaging system comprises a LIDAR-based system and the second modality imaging system comprises a camera-based system.

In a seventh aspect, in combination with one or more of the first aspect through the sixth aspect, processing the first input data samples in the first modality imaging system includes determining intermediate 3D point cloud features based on the first input data samples, and processing the second input data samples in the second modality imaging system includes determining intermediate camera features based on the second input data samples. In the seventh aspect, the operations further include training the second modality imaging system based on the intermediate 3D point cloud features.

In an eighth aspect, in combination with one or more of the first aspect through the seventh aspect, the first output includes a first plurality of bounding boxes corresponding to first objects in a scene, and the second output includes a second plurality of bounding boxes corresponding to second objects in the scene, and training the second modality imaging system includes training the second modality imaging system with a subset of the first and second objects, the objects of the subset being in both the first plurality of bounding boxes and the second plurality of bounding boxes.

In a ninth aspect, in combination with one or more of the second aspect through the eighth aspect, a non-transitory computer-readable medium stores instructions that, when executed by an image signal processor, cause the processor to perform operations including: training a first modality imaging system; receiving time-synchronized first input data samples and second input data samples from the first modality imaging system and a second modality imaging system, respectively; processing the first input data samples in the first modality imaging system to generate first output; processing the second input data samples in the second modality imaging system to generate second output; and training the second modality imaging system based on the first output and the second output.

In a tenth aspect, in combination with one or more of the second aspect through the eighth aspect, a method includes training a first modality imaging system; receiving time-synchronized first input data samples and second input data samples from the first modality imaging system and a second modality imaging system, respectively; processing the first input data samples in the first modality imaging system to generate first output; processing the second input data samples in the second modality imaging system to generate second output; and training the second modality imaging system based on the first output and the second output.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4 and 5 may be combined with one or more blocks (or operations) described with reference to another of the figures. For example, one or more blocks (or operations) of FIG. 4 may be combined with one or more blocks (or operations) of FIGS. 1-3. As another example, one or more blocks associated with FIG. 5 may be combined with one or more blocks (or operations) associated with FIGS. 5-9.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method, comprising:
training a first modality imaging system;
receiving first input data samples and second input data samples from the first modality imaging system and a second modality imaging system, respectively, the first input data samples and the second input data samples being time-synchronized;
processing the first input data samples in the first modality imaging system to generate first output;
processing the second input data samples in the second modality imaging system to generate second output; and
training the second modality imaging system based on the first output and the second output.

2. The method of claim 1, wherein training the first modality imaging system comprises: receiving third input data samples from the first modality imaging system; and determining a model for the first modality imaging system based on the first input data samples and a first ground truth corresponding to the first input data sample.

3. The method of claim 1, further comprising:
receiving third input data samples from the second modality imaging system; and
processing the third input data samples in the second modality imaging system to generate third output based on a model for the second modality imaging system that is trained based on the first output of the first modality imaging system.

4. The method of claim 3, wherein the third output comprises at least one bounding box corresponding to objects detected in the third input data samples.

5. The method of claim 4, further comprising operating a vehicle based on the at least one bounding box.

6. The method of claim 1, wherein the first modality imaging system comprises a LIDAR-based system and the second modality imaging system comprises a camera-based system.

7. The method of claim 1, wherein:
processing the first input data samples in the first modality imaging system comprises determining intermediate 3D point cloud features based on the first input data samples, and
processing the second input data samples in the second modality imaging system comprises determining intermediate camera features based on the second input data samples,
the method further comprising:
training the second modality imaging system based on the intermediate 3D point cloud features.

8. The method of claim 1, wherein:
the first output comprises a first plurality of bounding boxes corresponding to first objects in a scene, and
the second output comprises a second plurality of bounding boxes corresponding to second objects in a scene, and
training the second modality imaging system comprises training the second modality imaging system with a subset of the first and second objects, the objects of the subset being in both the first plurality of bounding boxes and the second plurality of bounding boxes.

9. A non-transitory computer-readable medium storing instructions that, when executed by a processor, cause the processor to perform operations comprising:
training a first modality imaging system;
receiving first input data samples and second input data samples from the first modality imaging system and a second modality imaging system, respectively, the first input data samples and the second input data samples being time-synchronized;
processing the first input data samples in the first modality imaging system to generate first output;
processing the second input data samples in the second modality imaging system to generate second output; and
training the second modality imaging system based on the first output and the second output.

10. The non-transitory computer-readable medium of claim 9, wherein training the first modality imaging system comprises: receiving third input data samples from the first modality imaging system; and determining a model for the first modality imaging system based on the first input data samples and a first ground truth corresponding to the first input data sample.

11. The non-transitory computer-readable medium of claim 9, wherein the operations further include:
receiving third input data samples from the second modality imaging system; and
processing the third input data samples in the second modality imaging system to generate third output based on a model for the second modality imaging system that is trained based on the first output of the first modality imaging system.

12. The non-transitory computer-readable medium of claim 11, wherein the third output comprises at least one bounding box corresponding to objects detected in the third input data samples.

13. The non-transitory computer-readable medium of claim 12, the operations further include operating a vehicle based on the at least one bounding box.

14. The non-transitory computer-readable medium of claim 9, wherein the first modality imaging system comprises a LIDAR-based system and the second modality imaging system comprises a camera-based system.

15. The non-transitory computer-readable medium of claim 9, wherein:
processing the first input data samples in the first modality imaging system comprises determining intermediate 3D point cloud features based on the first input data samples, and
processing the second input data samples in the second modality imaging system comprises determining intermediate camera features based on the second input data samples,
the operations further include:
training the second modality imaging system based on the intermediate 3D point cloud features.

16. The non-transitory computer-readable medium of claim 9, wherein:
the first output comprises a first plurality of bounding boxes corresponding to first objects in a scene, and
the second output comprises a second plurality of bounding boxes corresponding to second objects in a scene, and
training the second modality imaging system comprises training the second modality imaging system with a subset of the first and second objects, the objects of the subset being in both the first plurality of bounding boxes and the second plurality of bounding boxes.

17. An image capture device, comprising:
an image sensor;
a memory storing processor-readable code; and
at least one processor coupled to the memory and to the image sensor, the at least one processor configured to execute the processor-readable code to cause the at least one processor to perform operations including:
training a first modality imaging system;
receiving first input data samples and second input data samples from the first modality imaging system and a second modality imaging system, respectively, the first input data samples and the second input data samples being time-synchronized;
processing the first input data samples in the first modality imaging system to generate first output;
processing the second input data samples in the second modality imaging system to generate second output; and
training the second modality imaging system based on the first output and the second output.

18. The image capture device of claim 17, wherein training the first modality imaging system comprises: receiving third input data samples from the first modality imaging system; and determining a model for the first modality imaging system based on the first input data samples and a first ground truth corresponding to the first input data sample.

19. The image capture device of claim 17, wherein the operations further include:
receiving third input data samples from the second modality imaging system; and
processing the third input data samples in the second modality imaging system to generate third output based on a model for the second modality imaging system that is trained based on the first output of the first modality imaging system.

20. The image capture device of claim 19, wherein the third output comprises at least one bounding box corresponding to objects detected in the third input data samples.

21. The image capture device of claim 20, the operations further include operating a vehicle based on the at least one bounding box.

22. The image capture device of claim 17, wherein the first modality imaging system comprises a LIDAR-based system and the second modality imaging system comprises a camera-based system.

23. The image capture device of claim 17, wherein:
processing the first input data samples in the first modality imaging system comprises determining intermediate 3D point cloud features based on the first input data samples, and
processing the second input data samples in the second modality imaging system comprises determining intermediate camera features based on the second input data samples,
the operations further include:
training the second modality imaging system based on the intermediate 3D point cloud features.

24. The image capture device of claim 17, wherein:
the first output comprises a first plurality of bounding boxes corresponding to first objects in a scene, and
the second output comprises a second plurality of bounding boxes corresponding to second objects in a scene, and
training the second modality imaging system comprises training the second modality imaging system with a subset of the first and second objects, the objects of the subset being in both the first plurality of bounding boxes and the second plurality of bounding boxes.
